(19) United States
(12) Patent Application Publication
(10) Pub. No.: US 2017/0108359 A1
(43) Pub. Date: Apr. 20, 2017

(54) FLOATING PROBE MOUNT AND METHODS OF USE

(71) Applicant: Jason Harper, Alpharetta, GA (US)

(72) Inventor: Jason Harper, Alpharetta, GA (US)

(21) Appl. No.: 14/883,846

(22) Filed: Oct. 15, 2015

(51) Int. Cl. G01D 11/30

(52) U.S. Cl. CPC G01D 11/30

(57) ABSTRACT

A floating probe mount and methods of use, includes a triangular shaped vertical telescopic member having a first end and a second end, wherein each end includes a means to offset and adhere each end to a sidewall of a tank, a floating probe holder capable of holding one or more probes having a non-rotational notch configured to slidably mate with the vertical telescopic member and, thus, functions to maintain the probe holder about a changing fluid level line.

### TECHNICAL FIELD

The disclosure relates generally to probe supports and more specifically it relates to buoyant probe supports for aquarium tanks.

### BACKGROUND

Aquariums and adjacent fluid holding tanks require a plurality of sensors to measure and calibrate various fluid parameters, such as pH, temperature, salt content, and the like. To properly measure such parameters a set of electric sensing probes are attached to a fixed probe mount adjacent an initial tank water line. Such probes are able to measure parameters provided they are submerged in solution. A problem exists when water levels change in the aquarium or adjacent fluid holding tanks resulting in probes being dry docked or removed from the liquid. For instance, the water level changes when the water evaporates in an aquarium or is pumped between the aquarium and adjacent fluid holding tanks causing probes to be removed from their sensing liquid. One disadvantage of a fixed position probe is that a fluctuating fluid level relative to a fixed probe position may prevent continuous readings at all times.

Therefore, it is readily apparent that there is a recognizable unmet need for a floating probe mount and methods of use thereof that functions to maintain probes in contact with a fluctuating fluid line within an aquarium or adjacent fluid holding tank.

### BRIEF SUMMARY

Briefly described, in example embodiment, the present apparatus overcomes the above-mentioned disadvantage, and meets the recognized need for a floating probe mount and methods of use, by providing a triangular shaped vertical telescopic member having a first end and a second end, wherein each end includes a means to offset and adhere each end to a sidewall of a tank, a floating probe mount capable of holding one or more probes having a non-rotational notch configured to slidably mate with the vertical telescopic member and, thus, functions to maintain the probe mount about a changing fluid level line.

According to its major aspects and broadly stated, the disclosure is for a floating mount for aquarium probes. The mount would maintain probes in the water as level of the water would change. The mount would have vertical member which would be triangular or square to prevent the floating mount from twisting. The floating probe holder would be slidably affixed to the vertical member and able to travel up or down with fluid level change.

In a preferred embodiment, an apparatus to support one or more probes proximate a sidewall of an aquarium or holding tank having a water line, the apparatus including a vertical member, the vertical member having a first end and a second end, wherein each end includes a means to offset and adhere each end to the sidewall of the tank, a floating probe mount capable of holding the one or more probes, the floating probe mount includes a non-rotational notch configured to slidably mate with the vertical member, wherein the floating probe mount functions to maintain the one or more probes about a changing water line.

In still a further exemplary embodiment, a method of utilizing a floating probe mount to adjust a set of probes to a change of a water line in an aquarium, including the steps of providing an apparatus, the apparatus having a vertical member, an offset attachment device, and a floating probe holder for use in an aquarium, affixing a pair of offset attachment devices to the wall of the aquarium at each end of a possible range of the water line, positioning the vertical member within the possible range of water line, and positioning the floating probe holder with the set of probes therein to slidably travel up or down the vertical member about a range equivalent to the changing water line.

Accordingly, a feature of the floating probe mount is its ability to provide a vertical member, such as a rod or wire whether modular or telescopic in length to adjust the vertical member to a fluid level line range.

Another feature of the floating probe mount is its ability to be configured cross-sectional in other than a round configuration, such as triangle or square. Moreover, the floating probe mount comprises a similar notch or aperture to prevent the floating mount from twisting relative to the vertical member.

Still another feature of the floating probe mount is its ability to enable the probe mount configured with an aperture, which may be slidably affixed to the vertical member to allow the probe mount to travel or float up/down with fluid level for proper height adjustment of sensors positioned within the probe mount.

Yet another feature of the floating probe mount is its ability to provide support for a plurality of probe sensors.

Yet another feature of the floating probe mount is its ability to maintain probes in the water as level of the water would change.

Yet another feature of the floating probe mount is its ability to enable the probe mount to be slidably affixed to the vertical member and able to travel up or down with fluid level change.

Yet another feature of the floating probe mount is its ability to provide a telescopic vertical member to enable linear length adjustment of the vertical member equivalent to a possible fluid level range.

Yet another feature of the floating probe mount is its ability to provide suction cups at each end of the vertical member to affix the vertical member to a tank side wall.

Yet another feature of the floating probe mount is its ability to provide magnetic attachment devices at each end of the vertical member to affix the vertical member to a tank side wall.

Yet another feature of the floating probe mount is its ability to provide a floating probe mount formed from any floating material, such a styrofoam or the like.

Yet another feature of the floating probe mount is its ability to provide a floating probe mount not dependent on adhesivity vs. weight but rather a true independent floating probe mount.

These and other features of the floating probe mount will become more apparent to one skilled in the art from the following Detailed Description of the Embodiments and Claims when read in light of the accompanying drawing Figures.

### BRIEF DESCRIPTION OF THE DRAWINGS

The present floating probe mount will be better understood by reading the Detailed Description of the embodiments with reference to the accompanying drawing figures, in which like reference numerals denote similar structure and refer to like elements throughout, and in which:

FIG. 1 is a perspective view of an exemplary embodiment of a floating probe mount;

FIG. 2 is an exploded view of an exemplary embodiment of a floating probe mount;

FIG. 2A is a perspective view of an exemplary embodiment of an alternate floating probe holder;

FIG. 2B is a perspective view of an exemplary embodiment of an alternate floating probe holder;

FIG. 3 is a perspective view of an exemplary embodiment of a floating probe mount with probes inserted therein;

FIG. 4 is a perspective view of an example embodiment of support apparatus shown in operation; and

FIG. 5 is a flow diagram of a method of utilizing a floating probe mount to adjust a set of probes to a changing water line along a wall of an aquarium.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

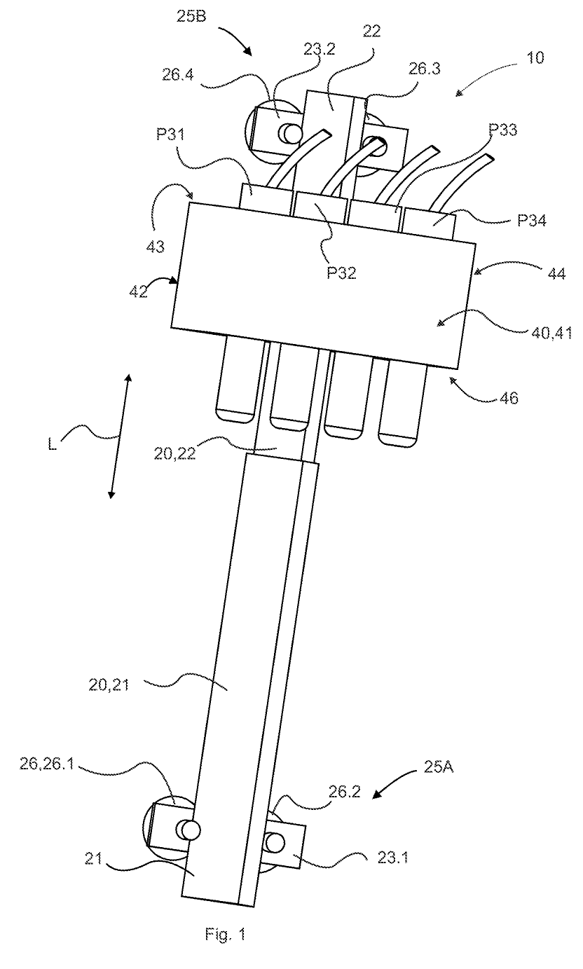

In describing the exemplary embodiments of the present disclosure, as illustrated in FIGS. 1, 2, 2A, 2B, 3, 4, 5, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples. The example devices used herein may be affixed to wall W of an adjacent fluid holding tanks or aquarium A and may be positioned about an initial water line WL₁.

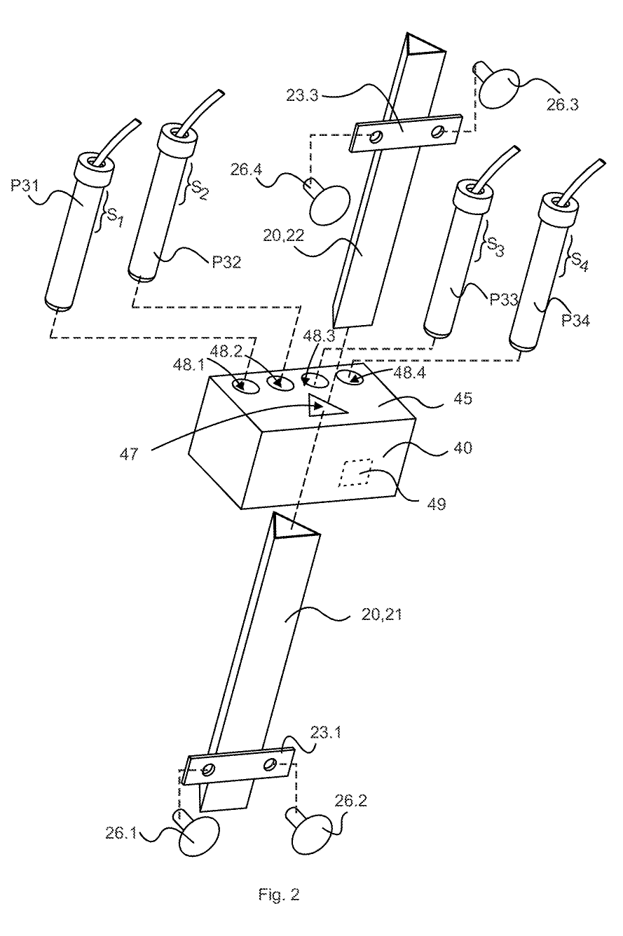

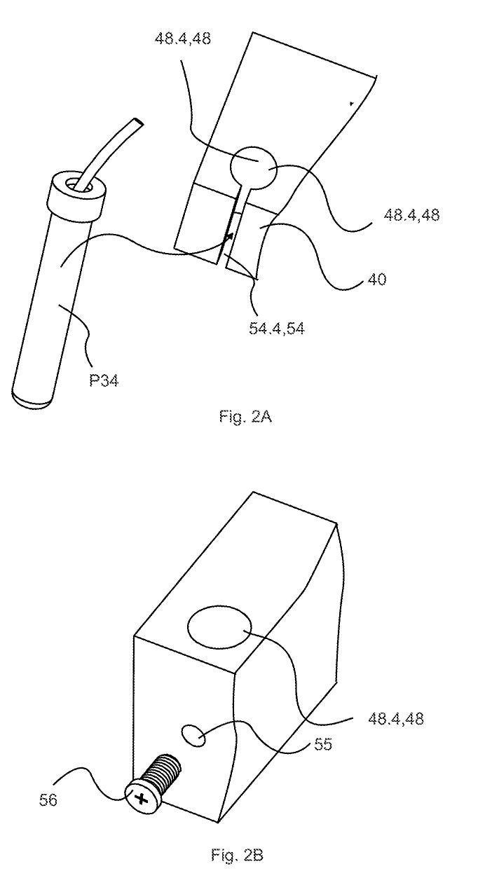

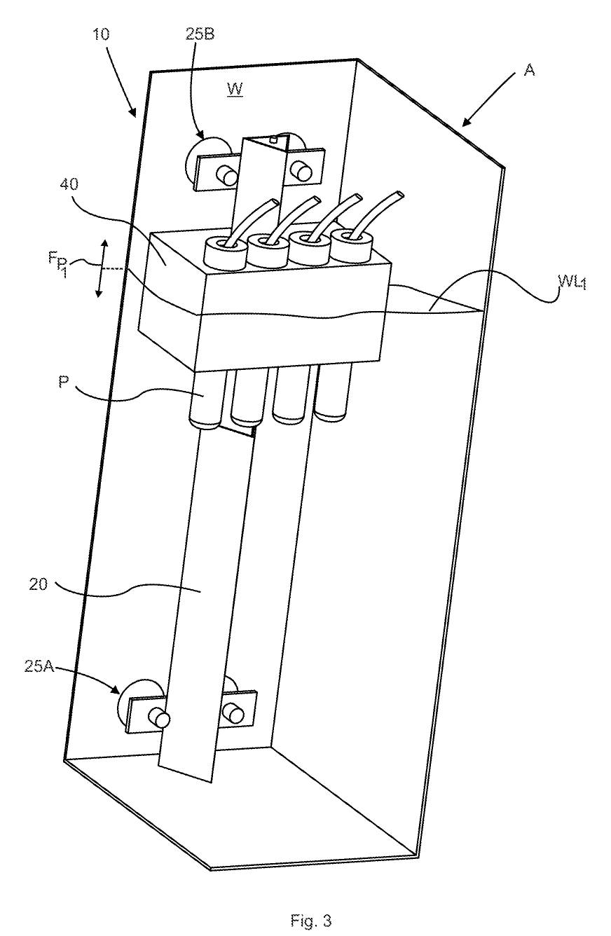

Referring now to FIG. 1 and FIG. 2, by way of example, and not limitation, there is illustrated an example embodiment of floating probe mount 10, which includes vertical member 20, offset attachment device 25, and floating probe holder 40. Preferably vertical member 20 includes two or more sections, such as first section end 21 and second section end 22, wherein such sections may be configured to be telescopic, interlaced, or slidable one within the other to enable extension of vertical member 20 in a linear length L (length or linear adjustment). Moreover, vertical member 20 may be configured with a cross-section as a triangular, square, circle, rectangle, the same having a notch 47, slot or groove, or the like capable of limiting rotation or twist there around. First attachment device 25A may be positioned proximate first section end 21 of vertical member 20. First attachment device 25A may include support bar 23.1 having at least one attachment means 26, such as suction cups 26, including first suction cup 26.1 and second suction cup 26.2 attached thereto support bar 23.1. Moreover, second attachment device 25B may be positioned proximate second section end 22 of vertical member 20. Second attachment device 25B may include support bar 23.2 having at least one attachment means 26, such as suction cups 26, including third suction cup 26.3 and fourth suction cup 26.4 attached thereto support bar 23.2. It is recognized herein that attachment device 25A/B may be positionally affixed to wall W of aquarium A to hold floating probe mount 10 in a desired position relative to water line WL, as shown in FIG. 3. It is further recognized herein that attachment device 25A/B may be composed of a two plate system, such as one of metal material and the other of magnetic material to hold floating probe mount 10 in a desired position relative to water line WL, as shown in FIG. 3, such as Neptune MPR Magnetic Probe Holder.

Vertical member 20 and attachment devices 25A/B are preferably formed, molded or configured from a suitable a rigid material, such as acrylic, plastic, silicone, rubber, fiber, wood, metal, aluminum, alloy, stainless steel, neodymium magnets, or the like, capable of providing structure to vertical member 20 and attachment devices 25A/B. Preferably, the material includes other suitable characteristics, such as adhesion, durability, water-resistance, thermal neutrality, clean-ability, light weight, pliability, resilience, chemical inertness, oxidation resistance, safety, smoothness, ease of workability, longevity, or other beneficial characteristic understood by one skilled in the art.

Furthermore, floating probe holder 40 is preferably positioned between attachment device 25A and attachment device 25B and about vertical member 20. Floating probe holder 40 includes a sliding aperture, such as non-rotational notch 47 configured therethrough holder 40 to slidably mate therewith vertical member 20 wherein a cross-section of non-rotational notch 47 may be configured via a cross-section as a triangular, square, rectangle, the same slotted, or the like capable of limiting rotation or twisting there around and slidably mating therewith for height adjustment up and down vertical member 20. It is contemplated herein that floating probe holder 40 may preferably maintain probes in the water as level of the water changes. For example, as the liquid level decreases the weight of floating probe holder 40 will overcome the adhesivity effect between floating probe holder 40 and vertical member 20, and floating probe holder 40 will preferably slide down vertical member 20 to a new equilibrium position. Conversely, the same effect will be noted if the liquid level is raised and the buoyant floating probe holder 40 by reason of the forces of buoyancy is raised relative to vertical member 20 and the side wall W of aquarium A. Note this movement is not based on buoyancy of probe P.

Preferably, probe holder 40 includes top surface 45, bottom surface 46, and one or more sides, such first side 41, second side 42, third side 43, and fourth side 44 configured in the shape of a rectangular solid. It is contemplated that configurations other than a rectangular are contemplated herein, including, without limitation a cubic, polygonal or other shapes.

Referring again to FIG. 2, floating probe holder 40 may include one or more friction fit apertures, such as bore 48 (one or more bores 48.1, 48.2, 48.3, 48.4 shown) configured to form a contact fit therearound section S (S.1, S.2, S.3, S.4 shown) of probe P (P31, P32, P33, P34 shown). Also each bore 48 is preferably positioned between top surface 45 and therethrough to bottom surface 46 and capable of holding one such probe P even if such probe P is not comprised of a buoyant body or means. It is contemplated herein that bore 48 of probe holder 40 may be formed with side entry slot 54 (one slot, such as 54.1, 54.2, 54.3, 54.4 integrated with one of one or more bores 48.1, 48.2, 48.3, 48.4) as shown in FIG. 2A or one or more threaded hole 55 proximate one or more bore 48 to receive fastening bolt 56 (one threaded hole, such as 55.1, 55.2, 55.3, 55.4 integrated with one of fastening bolt 56.1, 56.2, 56.3, 56.4) as shown in FIG. 2B) as alternate means of securing probe P therein bore 48.

It is recognized herein that floating probe holder 40 may tilt under the weight of probe P (P31, P32, P33, P34) and cause floating probe holder 40 to catch on vertical member 20. Floating probe holder 40 may include counter weight 49 to offset weight of probe P (P31, P32, P33, P34) and maintain floating probe holder 40 in-line with vertical member 20. Alternatively, probe P (P31, P32, P33, P34) and notch 47 may be configured in-line or centered therein floating probe holder 40 to reduce or prevent floating probe holder 40 from catching on vertical member 20. Furthermore, vertical member 20 or notch 47 may be configured with a cross-section as a triangular, square, circle, rectangle, the same having a notch 47, slot or groove, or the like capable of limiting tilt of floating probe holder 40 under the weight of probe P (P31, P32, P33, P34). Still floating probe holder 40 may include a support member, arm or guide that extends from top surface or bottom surface 46 includes top surface 45, bottom surface 46 proximate notch 47 to limit tilt of floating probe holder 40 under the weight of probe P (P31, P32, P33, P34).

Floating probe holder 40 is preferably formed, molded or configured from a suitable buoyant material, such as expanded polypropylene, polyethylene, polystyrene, or alternatively: foam, inflatable material, gel filled material, foam filled material, wood, or the like, capable of providing floatation characteristics for holder 40 to a changing fluid level, such as water line WL. Preferably, the material includes other suitable characteristics, such as durability, water-resistance, thermal neutrality, cleanability, light weight, pliability, resilience, chemical inertness, oxidation resistance, safety, smoothness, ease of workability, longevity, or other beneficial characteristic understood by one skilled in the art. It is contemplated herein that floating probe holder 40 would maintain probes P in the water as level of the water would change enabling floating probe holder 40 to slidably travel up or down vertical member 20 with fluid level change of water line WL.

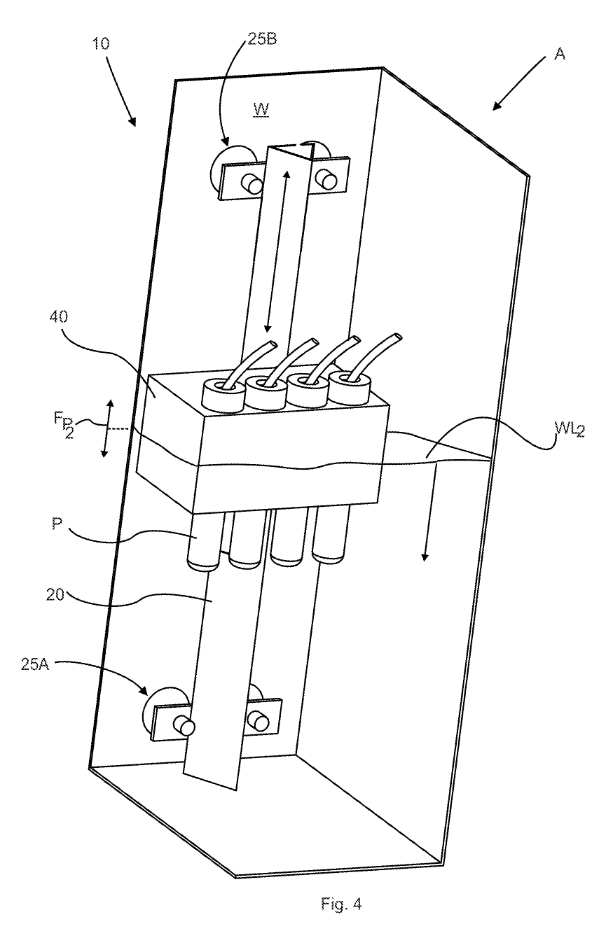

Referring now to FIG. 3 and FIG. 4, by way of example, and not limitation, there is illustrated an example embodiment of floating probe mount 10 affixed thereto wall W of aquarium A. In use, attachment device 25A and attachment device 25B are positioned about a range of water line WL, with the objective to position vertical member 20 thereto wall W of aquarium A within a possible range of water line WL. Floating probe holder 40 is preferably configured to slidably travel up or down vertical member 20 within a possible range of water line WL.

Again in FIG. 3, floating probe holder 40 preferably maintains probes P submerged below or therein first water line WL1 at floating position FP1. Once the water line WL changes to second water line WL2 as shown in FIG. 4 floating probe holder 40 is preferably configured to slidably travel up or down, shown travelling down, vertical member 20 with fluid level change of water line WL2 to maintain probes P submerged below or therein water line WL2 at floating position FP2.

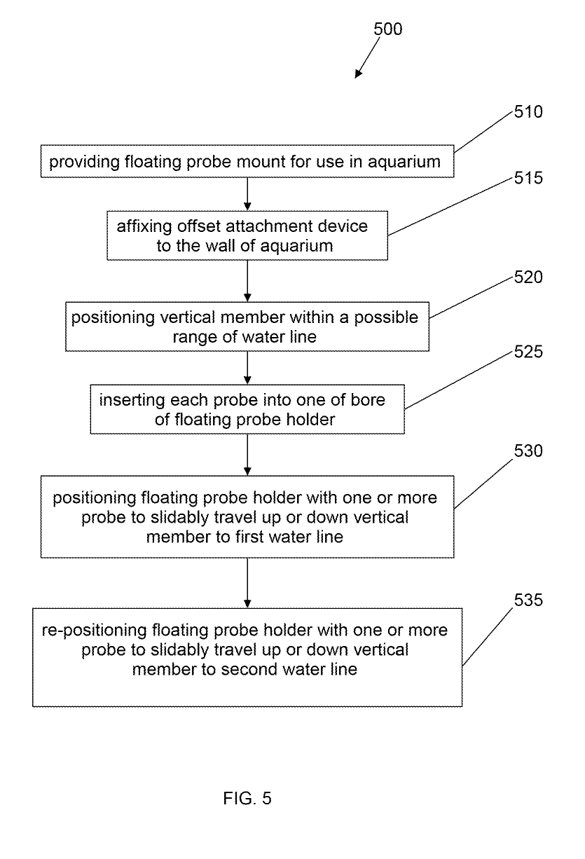

Referring now to FIG. 5, there is illustrated a flow diagram 500 of a method of utilizing a floating probe mount to adjust a set of probes P to a changing water line WL in an aquarium A. In block or step 510, providing floating probe mount 10 having vertical member 20, offset attachment device 25, and floating probe holder 40 for use in aquarium A, as described above in FIGS. 1-4. In block or step 515, affixing offset attachment device 25A and 25B to wall W of aquarium A at each end of a possible range of water line WL. In block or step 520, positioning vertical member 20 within a possible range of water line WL. In block or step 525, inserting each probe P into one of bore 48 of floating probe holder 40. In block or step 530, positioning floating probe holder 40 with one or more probe P therein and integrated holder 40 and probes P to slidably travel up or down vertical member 20 to position one, such as first water line WL1 to maintain probes P submerged below water line WL1. In block or step 535, re-positioning floating probe holder 40 with one or more probe P therein and integrated holder 40 and probes P to slidably travel up or down vertical member 20 to position two, such as second water line WL2 to maintain probes P submerged below water line WL2.

The foregoing description and drawings comprise illustrative embodiments of the present disclosure. Having thus described exemplary embodiments, it should be noted by those ordinarily skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments of the disclosure will come to mind to one ordinarily skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein, but is limited only by the following claims.

What is claimed is:

1. A floating probe mount apparatus to support one or more probes proximate a sidewall of an aquarium or holding tank having a water line, said apparatus comprising:
a vertical member, said vertical member having a first end and a second end, wherein each end includes a means to offset and adhere each end to the sidewall of the tank;
a floating probe holder capable of holding the one or more probes, said floating probe holder includes a non-rotational notch configured to slidably mate with said vertical member;
wherein said floating probe mount functions to maintain the one or more probes about a changing water line.

2. The apparatus of claim 1, wherein said vertical member comprises a telescopic or slidable member.

3. The apparatus of claim 2, said vertical member further includes two or more sections interlaced to enable a linear adjustment of said vertical member to a range equivalent the water line.

4. The apparatus of claim 1, wherein said vertical member further includes a cross-section selected from the group consisting of a triangle, a square, or combinations thereof to prevent said floating probe holder from twisting relative to said vertical member.

5. The apparatus of claim 1, wherein said floating probe holder further comprises one or more bores configured to form a contact fit therearound a section of the one or more probes.

6. The apparatus of claim 1, wherein said floating probe holder is configured with an aperture, said aperture slidably affixed to said vertical member.

7. The apparatus of claim 1, wherein said means to offset and adhere further comprises suction cups.

8. The apparatus of claim 1, wherein said means to offset and adhere further comprises a magnetic attachment device on one side of the sidewall and a metal plat on the other side of the sidewall.

9. The apparatus of claim 1, wherein said floating probe holder is formed from a buoyant material capable of providing floatation characteristics.

10. The apparatus of claim 1, wherein said vertical member is formed from a rigid material capable of providing structure to vertical member.

11. The apparatus of claim 1, wherein said floating probe holder maintains the one or more probes submerged therein a first water line.

12. The apparatus of claim 1, wherein said floating probe holder maintains the one or more probes submerged therein a second water line.

13. The apparatus of claim 1, wherein said floating probe holder maintains the one or more probes submerged about a range equivalent to the changing water line.

14. The apparatus of claim 1, wherein said one or more bores is further configured having a side entry slot.

15. The apparatus of claim 1, wherein said one or more bores is further configured having threaded holes proximate said bore to receive a fastening bolt.

16. A method of utilizing a floating probe mount to adjust a set of probes to a changing water line along a wall of an aquarium, said method comprising the steps of:
providing a floating probe mount apparatus, said apparatus having a vertical member, an offset attachment device, and a floating probe holder for use in the aquarium;
affixing said offset attachment devices to the wall of the aquarium at each end of the water line;
positioning said vertical member within said possible range of water line; and
positioning said floating probe holder with the set of probes therein to slidably travel up or down said vertical member about a range equivalent to the changing water line.

17. The method of claim 16, further comprising the step of positioning said floating probe holder up or down said vertical member to a position one, wherein the set of probes are submerged below a first water line.

18. The method of claim 17, further comprising the step of re-positioning said floating probe holder up or down said vertical member to a position two, wherein the set of probes are submerged below a second water line.
